(19) United States
(12) Patent Application Publication
(10) Pub. No.: US 2015/0154714 A1
(43) Pub. Date: Jun. 4, 2015

(54) SERVICE PROVISION METHOD

(71) Applicant: Panasonic Intellectual Property Corporation of America, Torrance, CA (US)

(72) Inventors: Aki Yoneda, Hyogo (JP); Tomohiko Kitamura, Osaka (JP); Kozo Nishimura, Osaka (JP); Shunji Harada, Osaka (JP); Kouji Miura, Osaka (JP)

(73) Assignee: Panasonic Intellectual Property Corporation of America, Torrance, CA (US)

(21) Appl. No.: 14/409,557

(22) PCT Filed: May 1, 2014
(86) PCT No.: PCT/JP2014/002391

§ 371 Date: Dec. 19, 2014

(30) Foreign Application Priority Data
May 8, 2013 (JP) 2013-098057

(51) Int. Cl. G06Q 40/08

(52) U.S. Cl. CPC G06Q 40/08

(57) ABSTRACT

A premium update system includes: an article transmission unit (607) which transmits via a network an article by a policy holder who has signed a predetermined contract with a service provider providing a predetermined service; an article display unit (609) which displays the article transmitted by the article transmission unit (607) to a viewer other than the policy holder; an interaction degree determination unit (901) which determines an interaction degree showing the degree of interaction relationship between the policy holder and the viewer; and a premium update unit (604) which determines the content (premium) of the contract in accordance with the interaction degree determined by the interaction degree determination unit (901).

### TECHNICAL FIELD

The present invention relates to a service providing method of determining the content of a contract to be signed with a service provider providing a predetermined service.

### BACKGROUND ART

In a conventional medical insurance or life insurance, the premium is determined at the time of purchase, and the premium is fixed until maturity. That is, even if the insured falls sick during a contract term, the premium does not change. This means that there is a possibility of an increase in the risk for an insurance company.

Since an insurance company transfers the risk to the premium, even a healthy person has to pay a relatively expensive premium. Alternatively, there is a possibility of an insurance company rejecting a contract with a person with even a slight health concern, in order to minimize the risk after a contract is made. There is also a possibility of an increase in items of a medical examination before a contract is made, in order to clarify the problem in terms of health. This results in a problem for a person interested in purchasing insurance that insurance cannot be purchased freely and a problem for an insurance company that the number of contracts decreases.

Due to such background, an insurance contract renewal system that dynamically changes the premium in accordance with the health state of the insured has been proposed (for example, see Patent Literature 1). In Patent Literature 1, a system is proposed in which the number of steps taken by the insured each day is measured with a pedometer mounted to a mobile phone terminal, the measured number of steps is transmitted to a server of an insurance company, the average number of steps per day is calculated from the received number of steps, and in which a contract renewal is performed for a party to an insurance contract using a insurance contract level corresponding to the calculated average number of steps per day.

However, further improvement has been necessary for the system in Patent Literature 1.

### CITATION LIST

### Patent Literature

Patent Literature 1: Japanese Patent No. 4432242

### SUMMARY OF INVENTION

A service providing method according to one aspect of the present invention includes: a transmitting step of transmitting via a network an article by a policy holder who has signed a predetermined contract with a service provider providing a predetermined service; a displaying step of displaying the article transmitted in the transmitting step to a viewer other than the policy holder; an interaction degree determining step of determining an interaction degree showing a degree of interaction relationship between the policy holder and the viewer is determined; and a contract determining step of determining content of the contract is determined in accordance with the interaction degree determined in the interaction degree determining step.

### BRIEF DESCRIPTION OF DRAWINGS

FIG. 1A is a diagram showing an overview of a service provided by a control system in this embodiment, FIG. 1B is a diagram showing an example in which a device manufacturer corresponds to a data center operating company, and FIG. 1C is a diagram showing an example in which both or one of a device manufacturer and a management company corresponds to the data center operating company.

FIG. 2 is a diagram showing the configuration of a premium update system in Embodiment 1 of the present invention.

FIG. 3 is a flowchart for illustrating the operation of the premium update system in Embodiment 1 of the present invention.

FIG. 4 is a diagram showing one example of a display screen displayed by an article display unit in Embodiment 1.

FIG. 5 is a diagram showing one example of a display screen notifying a user of an updated premium in Embodiment 1.

FIG. 6 is a diagram showing the configuration of a premium update system in Embodiment 2 of the present invention.

FIG. 7 is a flowchart for illustrating the operation of the premium update system in Embodiment 2 of the present invention.

FIG. 8 is a diagram showing one example of a display screen notifying a user of an updated premium using an SNS real interaction degree in Embodiment 2.

FIG. 9 is a diagram showing the configuration of a service providing system in Embodiment 3 of the present invention.

FIG. 10 is a schematic diagram for illustrating the relationship of a user and a service provider upon starting provision of a service.

FIG. 11 is a schematic diagram for illustrating the relationship of the user and the service provider in the case where the user has returned a good before passing of a return deadline.

FIG. 12 is a schematic diagram for illustrating the relationship of the user and the service provider in the case where the user has not returned a good even upon passing of a return deadline.

FIG. 13 is a diagram showing one example of a display screen displayed by an article display unit in Embodiment 4.

FIG. 14 is a diagram showing another example of an icon within a display screen displayed by the article display unit in Embodiment 4.

FIG. 15 is a diagram showing another example of an icon within a display screen displayed by the article display unit in Embodiment 4.

FIG. 16 is a diagram showing an overview of a service provided by an information providing system in service type 1 (company-owned data center-type cloud service).

FIG. 17 is a diagram showing an overview of a service provided by an information providing system in service type 2 (IaaS utilizing-type cloud service).

FIG. 18 is a diagram showing an overview of a service provided by an information providing system in service type 3 (PaaS utilizing-type cloud service).

FIG. 19 is a diagram showing an overview of a service provided by an information providing system in service type 4 (SaaS utilizing-type cloud service).

### DESCRIPTION OF EMBODIMENTS

(Finding on which the Present Invention is Based)

With the system in Patent Literature 1, the premium can be changed dynamically in accordance with the health state of the insured. Thus, the problems for both an insurance policyholder and an insurance company that occur due to a fixed premium with a conventional medical insurance and life insurance are resolved.

However, with the conventional system, there is a possibility of posing a new problem. A policy holder knows that the premium is reduced by increasing the number of steps reported to an insurance company. Therefore, a policy holder who wants to reduce the premium may report a false number of steps to the insurance company. For example, a child of a policy holder can hold a pedometer and engage in an activity instead of the policy holder him/herself holding the pedometer, so that the premium can be reduced even if the policy holder him/herself does not engage in activity for health.

An insurance company must prevent such fraud, but it is difficult to confirm that data of a pedometer is unmistakably of the insured. Therefore, an insurance company has no choice but to trust the conscience of the insured, and a method of confirming that the activity amount as a key point in a premium update is really of the insured is not considered.

In order to solve such a problem, the inventors of the present invention have conceived of the invention with the following aspects.

A service providing method according to one aspect of the present invention includes: a transmitting step of transmitting via a network an article by a policy holder who has signed a predetermined contract with a service provider providing a predetermined service; a displaying step of displaying the article transmitted in the transmitting step to a viewer other than the policy holder; an interaction degree determining step of determining an interaction degree showing a degree of interaction relationship between the policy holder and the viewer is determined; and a contract determining step of determining content of the contract is determined in accordance with the interaction degree determined in the interaction degree determining step.

In the transmitting step, with this configuration, the article is transmitted via the network by the policy holder who has signed the predetermined contract with the service provider providing the predetermined service. In the displaying step, the transmitted article is displayed with respect to the viewer other than the policy holder. In the interaction degree determining step, the interaction degree showing the degree of the interaction relationship of the policy holder and the viewer is determined. In the contract determining step, the content of the contract is determined in accordance with the determined interaction degree.

Thus, since the content of the contract is determined in accordance with the interaction degree showing the degree of the interaction relationship of the policy holder transmitting the article via the network and the viewer other than the policy holder viewing the transmitted article, the risk at the time of determining the content of contract can be reduced further.

In the aspect described above, it is preferable for the interaction degree determining step to be implemented such that the interaction degree is increased in a case where a real name of the policy holder is displayed to be viewable to the viewer together with the article transmitted by the policy holder.

In this case, the interaction relationship of the policy holder and the viewer can be determined to be closer by the real name of the policy holder being displayed to be viewable to the viewer.

In the aspect described above, it is preferable for the interaction degree determining step to be implemented such that the interaction degree is increased in a case where an address of the policy holder is displayed to be viewable to the viewer together with the article transmitted by the policy holder.

In this case, the interaction relationship of the policy holder and the viewer can be determined to be closer by the address of the policy holder being displayed to be viewable to the viewer.

In the aspect described above, it is preferable for the interaction degree determining step to be implemented such that the interaction degree is increased in a case where a face image of the policy holder is displayed to be viewable to the viewer together with the article transmitted by the policy holder.

In this case, the interaction relationship of the policy holder and the viewer can be determined to be closer by the face image of the policy holder being displayed to be viewable to the viewer.

In the aspect described above, it is preferable for an image acquiring step of acquiring an image of an official identification of the policy holder to be further included, and the interaction degree determining step to be implemented such that, in a case where an image of an official identification of the policy holder acquired in the image acquiring step match a real name, an address, or a face image of the policy holder registered by the policy holder, the real name, the address, or the face image is determined as real, and the interaction degree is increased.

In this case, the image of the official identification of the policy holder is acquired in the image acquiring step. In the interaction degree determining step, the real name, the address, or the face image is determined as real, and the interaction degree is increased, in the case where the acquired image of the official identification of the policy holder and the real name, the address, or the face image of the policy holder registered by the policy holder match.

Thus, based on the image of the official identification of the policy holder, whether or not the real name, the address, or the face image of the policy holder is real can be determined.

In the aspect described above, it is preferable for a storing step of associating the policy holder with a viewer who is a friend of the policy holder and storing the friendly relationship between the policy holder with the viewer to be further included, and the interaction degree determining step to be implemented such that the interaction degree is increased in a case where the number of times a real name of the policy holder has been searched for by the viewer, or the number of times the viewer who has searched for a real name of the policy holder and the policy holder have been associated with each other as being in a friendly relationship is large

In this case, the policy holder and the viewer in a friendly relationship with the policy holder are associated and stored in the storing step. In the interaction degree determining step, the interaction degree is increased in the case where the number of times the real name of the policy holder has been searched for by the viewer, or the number of times the viewer that has searched for the real name of the policy holder and the policy holder have been associated with each other as being in a friendly relationship is large.

Thus, since it is possible to search for the real name of the policy holder if the viewer knows the real name of the policy holder, the interaction relationship of the policy holder and the viewer can be determined to be close. In the case where the viewer that has searched for the real name of the policy holder and the policy holder are associated with each other as being in a friendly relationship, the interaction relationship of the policy holder and the viewer can be determined to be closer.

In the aspect described above, it is preferable for a storing step of associating the policy holder with a viewer who is a friend of the policy holder and storing the friendly relationship between the policy holder with the viewer to be further included, and the interaction degree determining step to be implemented such that the interaction degree of the policy holder is determined in accordance with a level of interaction degree of the viewer associated as being in a friendly relationship with the policy holder in the storing step.

In this case, the policy holder and the viewer who is a friend of the policy holder are associated and stored in the storing step. In the interaction degree determining step, the interaction degree of the policy holder is determined in accordance with the level of interaction degree of the viewer associated as being in a friendly relationship with the policy holder.

Thus, if the interaction degree of the viewer associated as being in a friendly relationship with the policy holder is high, it is possible to increase the interaction degree of the policy holder associated as being in a friendly relationship with the viewer.

In the aspect described above, it is preferable for the interaction degree determining step to be implemented such that the interaction degree is increased in a case where an image, which includes a face image that is determined to be of a same face as a face image of the policy holder, has been transmitted a large number of times from the viewer.

In this case, the viewer transmitting the image including the face image that is determined to be of the same face as the face image of the policy holder can be determined as being in a friendly relationship in a real world with the policy holder. Therefore, if an image including the face image that is determined to be of the same face as in the face image of the policy holder has been transmitted a large number of times, the interaction degree can be determined to be increased.

In the aspect described above, it is preferable for the contract to include a medical insurance contract or a life insurance contract, and an activity amount acquiring step of acquiring activity amount information showing an activity amount of the policy holder to be further provided, the displaying step to be implemented such that the article transmitted in the transmitting step and the activity amount information acquired in the activity amount acquiring step are displayed to the viewer, and the contract determining step to be implemented such that a premium in the medical insurance contract or the life insurance contract is determined in accordance with the activity amount information acquired in the activity amount acquiring step and the interaction degree determined in the interaction degree determining step.

In this case, the contract includes the medical insurance contract or the life insurance contract. In the activity amount acquiring step, the activity amount information showing the activity amount of the policy holder is acquired. In the displaying step, the transmitted article and the acquired activity amount information are displayed with respect to the viewer. In the contract determining step, the premium in the medical insurance contract or the life insurance contract is determined in accordance with the acquired activity amount information and the determined interaction degree.

Thus, since the activity amount information showing the activity amount of the policy holder is displayed with respect to the viewer and the premium in the medical insurance contract or the life insurance contract is determined in accordance with the activity amount information and the interaction degree, an appropriate premium reflecting the activity amount of the policy holder can be determined. Since the activity amount is displayed with respect to the viewer, the premium can be determined using the activity amount that is highly reliable.

In the aspect described above, it is preferable for the activity amount information to include a movement amount of the policy holder.

In this case, an appropriate premium reflecting the movement amount of the policy holder can be determined. Since the movement amount of the policy holder is displayed with respect to the viewer, the premium can be determined using the activity amount that is highly reliable.

In the aspect described above, it is preferable for the movement amount to include the number of steps taken by the policy holder.

In this case, an appropriate premium reflecting the number of steps of the policy holder can be determined. Since the number of steps of the policy holder is displayed with respect to the viewer, the premium can be determined using the number of steps that is highly reliable.

In the aspect described above, it is preferable for the activity amount acquiring step to be implemented such that the number of steps taken by the policy holder is acquired by a pedometer owned by the policy holder.

In this case, the number of steps of the policy holder can be acquired by the pedometer owned by the policy holder.

In the aspect described above, it is preferable for the activity amount information to include body information on the policy holder.

In this case, an appropriate premium reflecting the body information of the policy holder can be determined. Since the body information of the policy holder is displayed with respect to the viewer, the premium can be determined using the body information that is highly reliable.

In the aspect described above, it is preferable for the body information to include any of a pulse, a blood pressure, a blood sugar level, and an uric acid level of the policy holder.

In this case, an appropriate premium reflecting one of the pulse, the blood pressure, the blood sugar level, and the uric acid level of the policy holder can be determined. Since one of the pulse, the blood pressure, the blood sugar level, and the uric acid level of the policy holder is displayed with respect to the viewer, the premium can be determined using one of the pulse, the blood pressure, the blood sugar level, and the uric acid level that is highly reliable.

In the aspect described above, it is preferable for the contract to include a rental contract to rent a good, and the contract determining step to be implemented such that whether or not a good is to be rented to the policy holder in the rental contract is determined in accordance with the interaction degree determined in the interaction degree determining step.

In this case, the contract includes the rental contract to rent a good. In the contract determining step, whether or not to rent a good to the policy holder in the rental contract is determined in accordance with the determined interaction degree.

Thus, since whether or not to rent a good to the policy holder in the rental contract is determined in accordance with the interaction degree, the reliability with respect to the policy holder can be determined with the interaction degree, and a good can be rented to a policy holder with higher reliability.

In the aspect described above, it is preferable for the contract to include a financing contract, and the contract determining step to be implemented such that whether or not financing is to be provided to the policy holder in the financing contract is determined in accordance with the interaction degree determined in the interaction degree determining step.

In this case, the contract includes the financing contract. In the contract determining step, whether or not to provide financing to the policy holder in the financing contract is determined in accordance with the determined interaction degree.

Thus, since whether or not to provide financing to the policy holder in the financing contract is determined in accordance with the interaction degree, the reliability with respect to the policy holder can be determined with the interaction degree, and financing can be provided to a policy holder with higher reliability.

A service providing method according to another aspect of the present invention includes: a transmitting step of transmitting via a network an article by a policy holder who has signed a predetermined contract with a service provider providing a predetermined service; an activity amount acquiring step in which activity amount information showing an activity amount of the policy holder is acquired; a displaying step of displaying the article transmitted in the transmitting step and the activity amount information acquired in the activity amount acquiring step to a viewer for which viewing has been permitted by the policy holder; and a contract determining steps of determining content of the contract in accordance with the activity amount information acquired in the activity amount acquiring step.

In the transmitting step, with this configuration, the article is transmitted via the network by the policy holder who has signed the predetermined contract with the service provider providing the predetermined service. In the activity amount acquiring step, the activity amount information showing the activity amount of the policy holder is acquired. In the displaying step, the transmitted article and the acquired activity amount information are displayed with respect to the viewer for which viewing has been permitted by the policy holder. In the contract determining step, the content of the contract is determined in accordance with the acquired activity amount information.

Thus, since the content of the contract is determined in accordance with the activity amount information showing the activity amount of the policy holder, appropriate content of the contract reflecting the activity amount of the policy holder can be determined. Since the activity amount is displayed with respect to the viewer, the content of the contract can be determined using the activity amount that is highly reliable.

Embodiments described below all show one specific example of the present invention. The numerical value, shape, component, step, order of steps, and the like shown in the embodiments below are one example and are not intended to limit the present invention. Of the components in the embodiments below, a component not described in an independent claim showing the broadest concept is described as an optional component. In all of the embodiments, various contents can be combined.

(Overview of Provided Service)

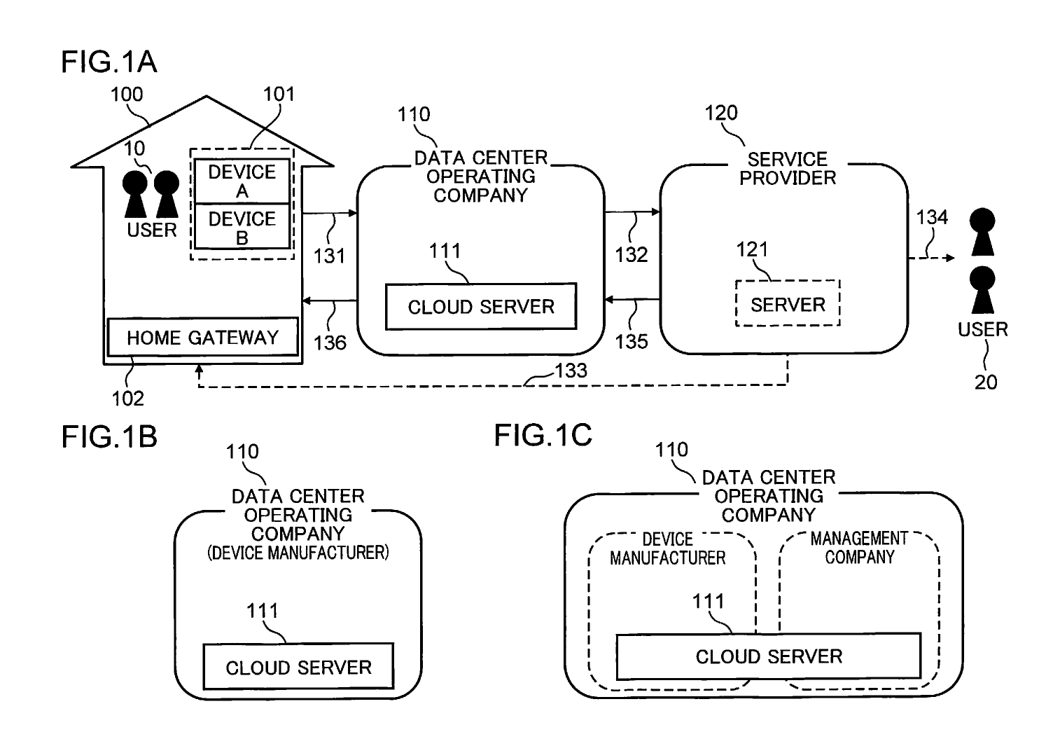

FIG. 1A is a diagram showing an overview of a service provided by an information providing system in this embodiment. The information providing system includes a group 100, a data center operating company 110, and a service provider 120.

The group 100 is, for example, an enterprise, an organization, or a home that may be of any size. In the group 100, a plurality of pieces of device 101 including device A and device B and a home gateway 102 are present. The plurality of pieces of device 101 include a pedometer that measures the activity amount (e.g., number of steps) of the insured. The plurality of pieces of device 101 include device (e.g., a smartphone built in with a pedometer) connectable to the Internet and device (e.g., a pedometer) not connectable to the Internet by itself. Even if the plurality of pieces of device 101 are pieces of device not connectable to the Internet by itself, device connectable to the Internet via the home gateway 102 may be included. For example, the pedometer may record the number of steps on that day in a built-in memory and transmit the recorded number of steps to the device connectable to the Internet via a wireless local area network (LAN). A user 10 uses the plurality of pieces of device 101 within the group 100.

In the data center operating company 110, a cloud server 111 is present. The cloud server 111 is a virtual server that cooperates with various pieces of device via the Internet. The cloud server 111 mainly manages huge data (big data) of which handling is difficult with a normal database management tool or the like. The data center operating company 110 performs data management, management of the cloud server 111, operation of a data center that performs the same, or the like. The details of service performed by the data center operating company 110 will be described later.

The data center operating company 110 is not limited to a company that performs only management of data, operation of the cloud server 111, or the like. For example, in the case where a device manufacturer developing and manufacturing one piece of device out of the plurality of pieces of device 101 performs management of data, management of the cloud server 111, or the like, the device manufacturer corresponds to the data center operating company 110, as shown in FIG. 1B. The data center operating company 110 is not limited to one company. For example, in the case where management of data or operation of the cloud server 111 is performed in cooperation or through task-sharing between a device manufacturer and another management company, both or one of the maker and the company correspond to the data center operating company 110, as shown in FIG. 1C.

In the service provider 120, a server 121 is present. The server 121 referred to herein may be of any size and includes, for example, a memory within a personal computer (PC). There are cases where the server 121 is absent in the service provider 120.

In the service, the home gateway 102 is not a requisite. For example, in the case where the cloud server 111 performs all of data management or the like, the home gateway 102 is unnecessary. There are cases where device not connectable to the Internet by itself is absent, as in the case where all pieces of device within a home are connected to the Internet.

Next, the flow of information in the service will be described.

First, the device A and the device B of the group 100 transmits each piece of log information to the cloud server 111 of the data center operating company 110. The cloud server 111 collects the log information of the device A and the device B (in an arrow 131 in FIG. 1A). The log information is information representing the health state of the user 10 or information representing the cause of change in the health state of the user 10 that is acquired by the plurality of pieces of device 101. For example, the log information includes the activity amount such as the number of steps or movement distance of the user 10 that is acquired by an acceleration sensor or vibration sensor included in a pedometer or the like. For example, the log information includes the pulse, blood pressure, blood sugar level, uric acid level, or the like of the user 10 that is acquired by medical device such as a pulse monitor. The log information is not limited to these pieces of information and may include all pieces of information acquirable from the user 10. The log information may be provided to the cloud server 111 directly from the plurality of pieces of device 101 themselves via the Internet. The log information may be collected in the home gateway 102 temporarily from the plurality of pieces of device 101 and provided to the cloud server 111 from the home gateway 102.

Next, the cloud server 111 of the data center operating company 110 provides the collected log information to the service provider 120 in certain units. The certain unit may be a unit in which the information collected by the data center operating company 110 can be organized and provided to the service provider 120 or may be a unit requested by the service provider 120. The log information is provided in certain units. However, the information amount to be provided may change in accordance with the situation, instead of being in certain units. The log information is saved in the server 121 held by the service provider 120 according to necessity (in an arrow 132 in FIG. 1A).

With the service provider 120, the log information is organized into information suited for a service provided to a user and is provided to the user. The user provided with the service may be the user 10 using the plurality of pieces of device 101 or may be an external user 20. As a service providing method for the user 10 or 20, a service may be provided to the user 10 or 20 directly from the service provider 120 (in arrows 133 and 134 in FIG. 1A), for example. As a service providing method for the user 10, a service for the user 10 may be provided through the cloud server 111 of the data center operating company 110 again, for example (in arrows 135 and 136 in FIG. 1A). With the cloud server 111 of the data center operating company 110, the log information may be organized into information suited for a service provided to a user and provided to the service provider 120.

The user 10 may be different from or be the same as the user 20.

The service provided by the service provider 120 described above is preferably a social networking service (SNS) or a service of updating the premium. The two services may be operated with service providers different from each other or may be operated with a single provider.

The cloud server 111 described above may be operated by a data center operating company separate from that of the service provider 120 or may be operated by the same data center operating company as that of the service provider 120. That is, the cloud server 111 may be the same as the server for one of the SNS and the service of updating the premium or may be the same as the server for both.

An embodiment of the present invention will be described below with reference to the drawings.

### Embodiment 1

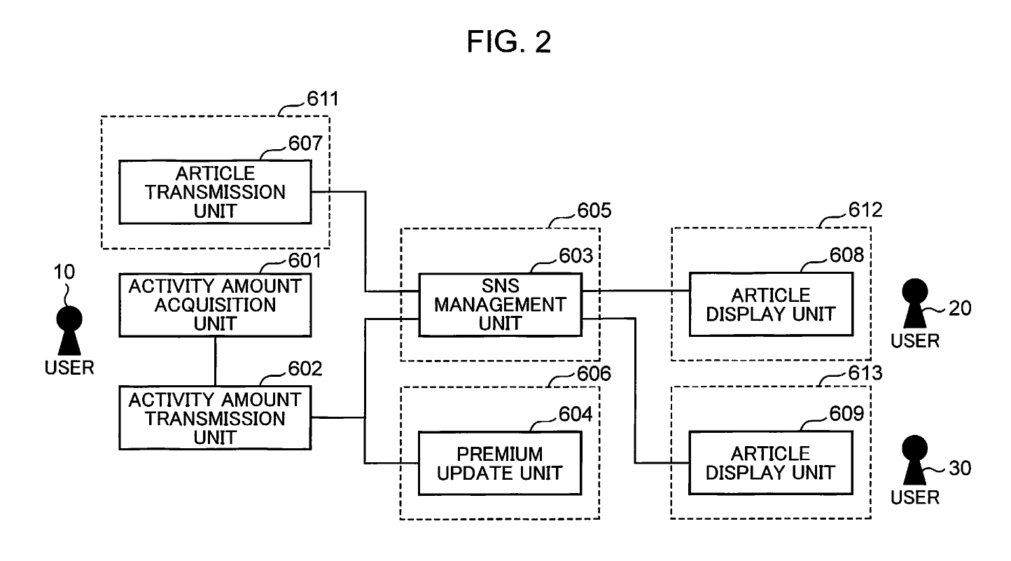

FIG. 2 is a diagram showing the configuration of a premium update system in Embodiment 1 of the present invention. The premium update system shown in FIG. 2 includes an activity amount acquisition unit 601, an activity amount transmission unit 602, an SNS management unit 603, a premium update unit 604, an article transmission unit 607, and article display units 608 and 609.

In FIG. 2, the user 10 has a medical insurance contract or life insurance contract with an insurance company with a condition of transmitting information relating to one's health acquired by the activity amount acquisition unit 601. That is, the user 10 is a policy holder who has signed a predetermined contract with a service provider providing a predetermined service.

The activity amount acquisition unit 601 corresponds to the device A or the device B in FIG. 1 and acquires information (referred to as activity amount information in this Embodiment 1) relating to the health of the user 10. The activity amount information includes the movement amount of the user 10. The movement amount includes the number of steps of the user 10. For example, the activity amount acquisition unit 601 is configured of a pedometer or the like and includes an acceleration sensor or a vibration sensor. The activity amount acquisition unit 601 acquires, as the activity amount, the number of steps or movement distance of the user 10 measured by the acceleration sensor or vibration sensor.

Alternatively, the activity amount acquisition unit 601 may be configured of medical device such as a pulse monitor. In this case, the activity amount information of the user 10 includes body information of the user 10. The body information includes the pulse, blood pressure, blood sugar level, uric acid level, or the like. The activity amount information is not limited to these pieces of information and includes all pieces of information acquirable from the user 10 and with which the health state of the user 10 can be determined directly or indirectly. A device that can acquire such activity amount information can be the activity amount acquisition unit 601.

The activity amount transmission unit 602 transmit the activity amount information acquired by the activity amount acquisition unit 601 to the SNS management unit 603 and the premium update unit 604. The activity amount transmission unit 602 is, for example, implemented with an Internet protocol or the like in terms of software and implemented with a mobile phone communication service such as a third-generation mobile communication system or Long Term Evolution (LTE), wireless local area network (LAN), Bluetooth (registered trademark), Ethernet (registered trademark), or the like in terms of hardware. The activity amount transmission unit 602 may be of any configuration as long as the activity amount can be transferred to the SNS management unit 603 and the premium update unit 604. The home gateway 102 in FIG. 1 may form a part of the activity amount transmission unit 602.

The article transmission unit 607 transmits an article input by the user 10 to the SNS management unit 603 via a network. The article transmission unit 607 is included in a terminal 611 such as, for example, a smartphone or personal computer. An article is, for example, an event that has actually occurred to the user (policy holder).

The SNS management unit 603 is preferably a computer system that provides a so-called social networking service and is included, for example, in a server 605 operated by a service provider corresponding to Facebook (registered trademark) or Mixi (registered trademark), for example. That is, the SNS management unit 603 saves an article posted by the user 10 that is transmitted by the article transmission unit 607 and provides a service of causing the saved article to be in a viewable state with respect to the user 20 or a user 30 that is in a friendly relationship in the system with the user 10 through the Internet or the like. It is desirable that the user 20 and the user 30 be friends of the user 10 in reality, but this is not limiting. The server 605 in FIG. 2 corresponds to the server 121 in FIG. 1.

The SNS management unit 603 transmits the article transmitted by the article transmission unit 607 to the article display units 608 and 609 in accordance with a request from the article display units 608 and 609.

The article display units 608 and 609 display the article transmitted by the SNS management unit 603 with respect to a viewer (the user 20 or user 30) other than the user 10. The article display units 608 and 609 are included in terminals 612 and 613 such as, for example, a smartphone or personal computer.

When the activity amount information of the user 10 is received from the activity amount transmission unit 602, the SNS management unit 603 saves the activity amount as an article of the user 10 in a similar manner to the article of the user 10 transmitted by the article transmission unit 607 and causes the saved article to be in a viewable state with respect to the user 20 or the user 30. Accordingly, the article display units 608 and 609 display the article transmitted by the article transmission unit 607 and the activity amount information acquired by the activity amount acquisition unit 601 with respect to the viewer. In this embodiment, the activity amount is transmitted to the SNS management unit 603 from the activity amount transmission unit 602 directly, but this is not limiting. The activity amount may be transmitted to the SNS management unit 603, i.e., the server 121 of the service provider 120 in FIG. 1, after being temporarily stored in the cloud server 111 of the data center operating company 110 in FIG. 1.

The premium update unit 604 is a computer system that provides an insurance business service and preferably includes a server 606 operated by a service provider corresponding to an insurance company. The server 606 in FIG. 2 corresponds to the server 121 in FIG. 1. The server 606 does not need to be the same server as the server 605 including the SNS management unit 603 and may be a different server. The service provider that operates the server 606 does not need to be the same service provider as the service provider that operates the server 605 and may be a different service provider.

The premium update unit 604 determines the content of a contract in accordance with the activity amount information acquired by the activity amount acquisition unit 601. The premium update unit 604 determines the premium in a medical insurance contract or life insurance contract in accordance with the activity amount information acquired by the activity amount acquisition unit 601.

The premium update unit 604 receives the activity amount information transmitted by the activity amount transmission unit 602 and collects the activity amount of a certain period, i.e., one month. Then, the premium update unit 604 evaluates the activity amount (health state) of the user 10 and updates the premium of the user 10 based on the evaluation result. In this embodiment, the activity amount information is transmitted to the premium update unit 604 from the activity amount transmission unit 602 directly, but this is not limiting. The activity amount may be transmitted to the server 606 of the insurance company, i.e., the server 121 of the service provider 120 in FIG. 1, after being temporarily stored in the cloud server 111 of the data center operating company 110 in FIG. 1, in a similar manner to the SNS management unit 603.

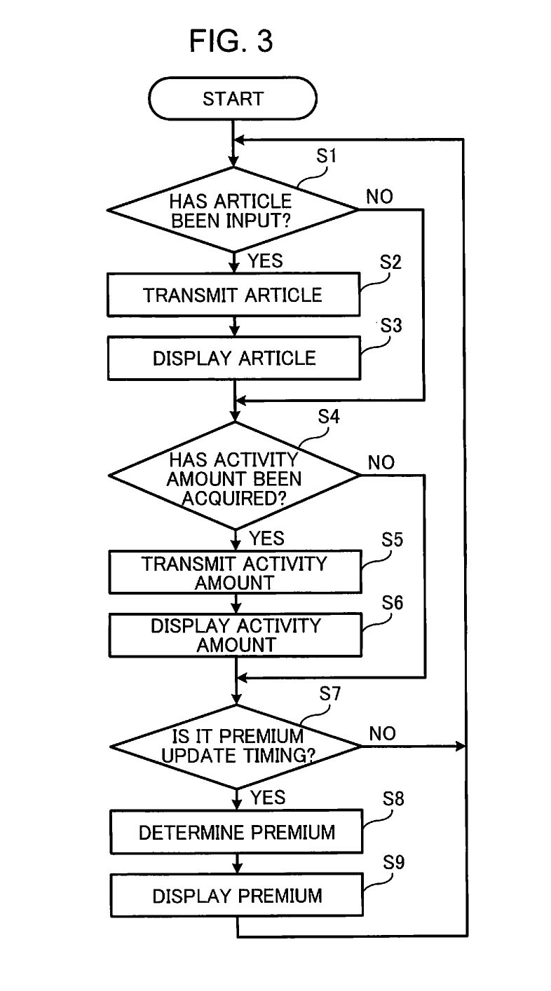

FIG. 3 is a flowchart for illustrating the operation of the premium update system in Embodiment 1 of the present invention.

First, in step S1, the article transmission unit 607 determines whether or not an article has been input by the user 10. At this time, the user 10 inputs an article using an input unit (not shown) included in the terminal 611. In the case where it is determined that an article is not input (NO in step S1), it proceeds to the processing in step S4.

In the case where it is determined that an article is input (YES in step S1), the article transmission unit 607 transmits the input article to the SNS management unit 603 in step S2.

Next, in step S3, the SNS management unit 603 transmits the received article to the article display unit 608 and the article display unit 609, and the article display unit 608 and the article display unit 609 display the received article. At this time, the SNS management unit 603 transmits the article transmitted from the article transmission unit 607 of the user 10 to the article display unit 608 and the article display unit 609 of the users 20 and 30 associated in advance as being in a friendly relationship with the user 10.

Next, in step S4, the activity amount transmission unit 602 determines whether or not the activity amount has been acquired by the activity amount acquisition unit 601. In the case where it is determined that the activity amount is not acquired (NO in step S4), it proceeds to the processing in step S7.

In the case where it is determined that the activity amount has been acquired (YES in step S4), the activity amount transmission unit 602 transmits the activity amount acquired by the activity amount acquisition unit 601 to the SNS management unit 603 and the premium update unit 604 in step S5. With the premium update unit 604, the received activity amount is associated with the user 10 and stored.

Next, in step S6, the SNS management unit 603 transmits the received activity amount to the article display unit 608 and the article display unit 609 as an article, and the article display unit 608 and the article display unit 609 display the received article (activity amount). At this time, the SNS management unit 603 transmits the article (activity amount) transmitted from the activity amount acquisition unit 602 of the user 10 to the article display unit 608 and the article display unit 609 of the users 20 and 30 associated in advance as being in a friendly relationship with the user 10.

Next, in step S7, the premium update unit 604 determines whether or not it is a premium update timing for updating the premium. For example, the premium update unit 604 updates the premium once a month. For example, the premium update unit 604 may determine the premium for the month using the activity amount of the previous month, at the start of the month. For example, the premium update unit 604 may determine the premium for the next month using activity amount of this month, at the end of the month. In the case where it is determined as not a premium update timing (NO in step S7), it returns to the processing in step S1.

In the case where it is determined as a premium update timing (YES in step S7), the premium update unit 604 determines the premium using the activity amount in step S8.

Next, in step S9, the premium update unit 604 transmits the determined premium to the terminal 611 of the user 10, and the terminal 611 displays the received premium. Then, it returns to the processing in step S1, and the processing of steps S1 and thereafter is performed.

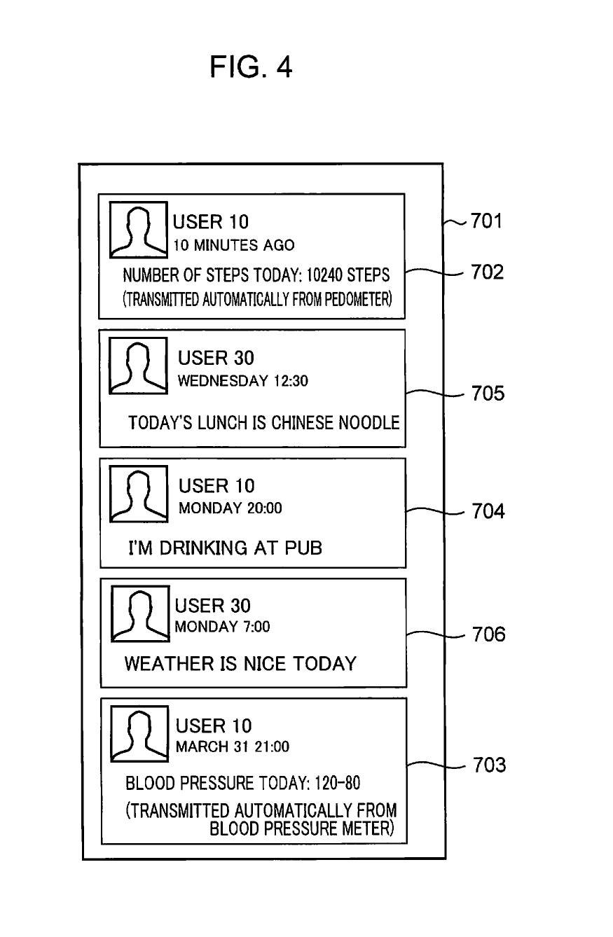

FIG. 4 is a diagram showing one example of a display screen displayed by the article display unit 608 in Embodiment 1. A display screen 701 displays an article posted by a friend of the user 20. Articles 702 and 703 represent articles transmitted respectively by users in a friendly relationship with the user 20. Herein, articles 702, 703, and 704 are articles transmitted by the user 10 that is a friend of the user 20, and articles 705 and 706 are articles transmitted by the user 30 that is another friend of the user 20. Through display of the display screen 701, the user 20 can know the recent situations of the user 10 and the user 30 that are friends.

The articles 702 and 703 are not articles input by the user 10 him/herself, but are activity amount information transmitted by the activity amount transmission unit 602 and acquired by the activity amount acquisition unit 601. That is, the activity amount of the user 10 is in a viewable state for the user 20. The article 702 represents the number of steps of the user 10 in one day that is acquired by a pedometer. The article 703 represents the blood pressure of the user 10 that is acquired by a blood pressure meter.

The premium update unit 604 receives the activity amount information with content similar to the articles 702 and 703 from the activity amount transmission unit 602 and updates the premium of the user 10 in accordance with the received activity amount information. The activity amount of the user 10 is in a viewable state for a friend (the user 20 and the user 30) of the user 10. Therefore, in the case where the user 10 has attached the activity amount acquisition unit 601 to someone else, e.g., a child, and fabricated the activity amount information, the fabrication is known to a friend, and the trust of the friend is lost. This acts as a deterrent, and it becomes difficult for the user 10 to fabricate the activity amount. With the configuration of this embodiment, the premium can be updated in a state where it is highly likely that the activity amount is real. Therefore, a significant effect that an insurance company can reduce the risk of insurance can be obtained.

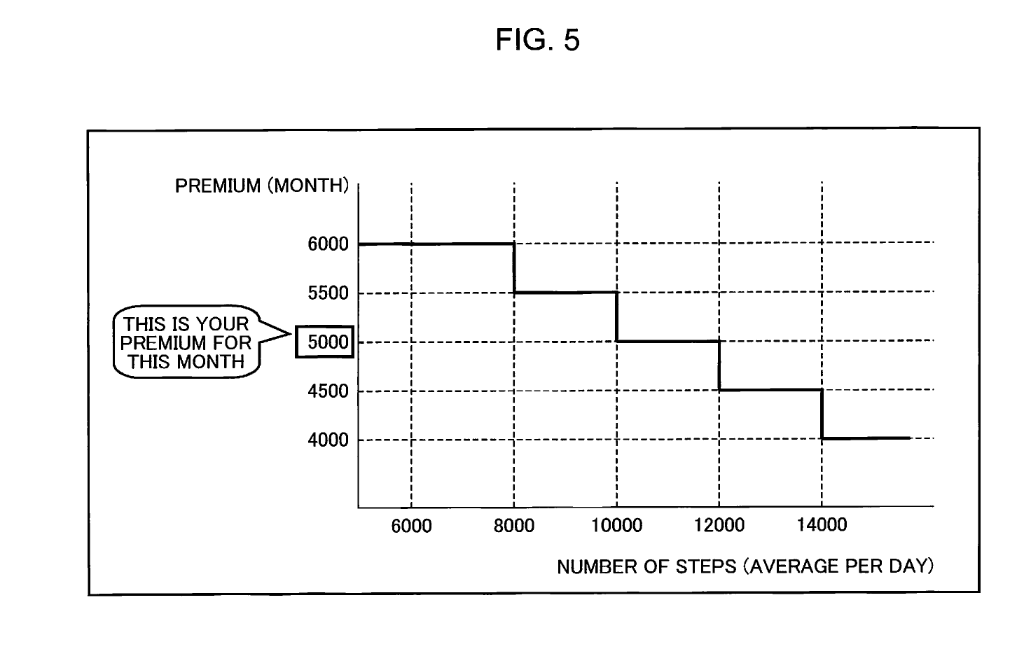

FIG. 5 is a diagram showing one example of a display screen notifying the user 10 of the updated premium in Embodiment 1. In FIG. 5, it is specified that the premium increases or decreases in accordance with the average number of steps (per day) in one month, and the premium for this month determined by the average number of steps (per day) in one month is further presented. As the average number of steps (per day) in one month increases, the premium update unit 604 decreases the premium. In the display screen shown in FIG. 5, the average number of steps of the user is between 10000 and 12000. Therefore, the premium update unit 604 determines the premium for one month as 5000 yen.

By the activity amount being displayed together with the premium in this manner, the user 10 can recognize the influence of one's own activity on the premium to become more engaged in activities to reduce the premium as a result. A reduction in premium is an advantage for the user 10. By the user 10 becoming healthy, the insurance risk decreases further. A decrease in insurance risk is an advantage for an insurance company. The premium shown as an example in FIG. 5 may be transmitted by e-mail to the terminal 611 (e.g. a smartphone) of the user 10 from the server 606 of the insurance company. The premium shown as an example in FIG. 5 may be transmitted by e-mailing an address (URL) on the Internet for displaying the display screen in FIG. 5 to the terminal 611 of the user 10 from the server 606 of the insurance company. The premium shown as an example in FIG. 5 may be notified to the user 10 by mail.

### Embodiment 2

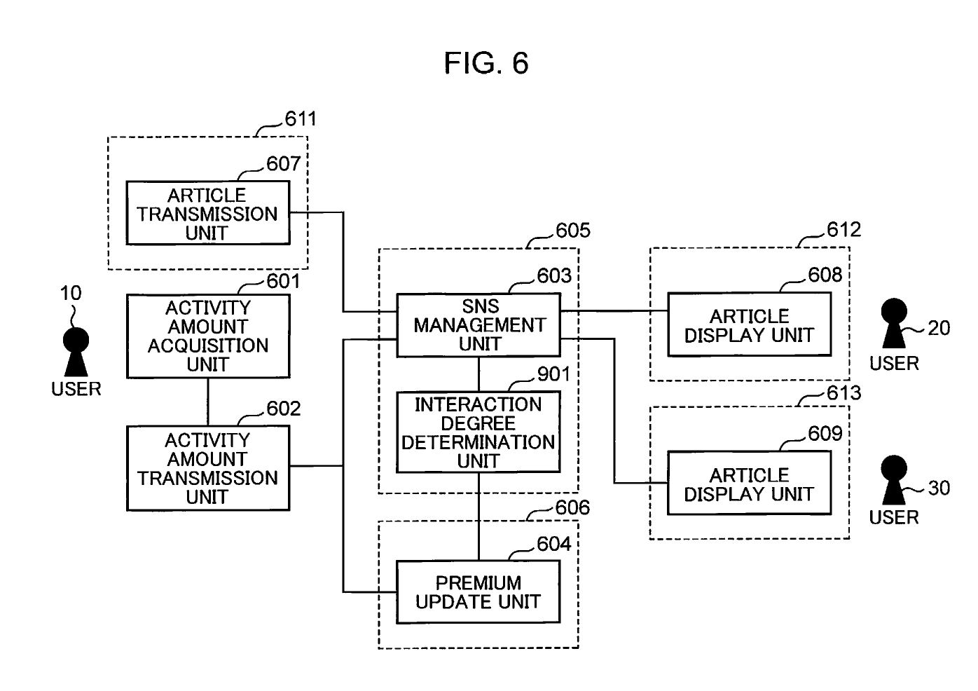

FIG. 6 is a diagram showing the configuration of a premium update system in Embodiment 2 of the present invention. The premium update system shown in FIG. 6 includes the activity amount acquisition unit 601, the activity amount transmission unit 602, the SNS management unit 603, the premium update unit 604, the article transmission unit 607, the article display units 608 and 609, and an interaction degree determination unit 901.

In FIG. 6, the interaction degree determination unit 901 determines an SNS real interaction degree showing the degree of interaction relationship of the user 10 (policy holder) and a viewer viewing an article transmitted by the user 10. The interaction degree determination unit 901 determines the SNS real interaction degree based on a posted article saved in the SNS management unit 603 or attribute information of a user. In the case where the viewer viewing the article transmitted by the user 10 is a virtual friend only within the system, the SNS real interaction degree decreases. In the case where the viewer viewing the article transmitted by the user 10 is a friend in reality with which there is actual acquaintance and there are normal social interactions, the SNS real interaction degree increases. The SNS real interaction degree is represented with a numerical value, for example, but the present invention is not particularly limited thereto. Representation may be with a level of high or low with respect to a predetermined value.

The premium update unit 604 is basically the same as the configuration described in Embodiment 1, but differs in that the premium is updated further utilizing the SNS real interaction degree determined by the interaction degree determination unit 901. The premium update unit 604 determines the content of a contract in accordance with the SNS real interaction degree determined by the interaction degree determination unit 901.

As one example, the server 605 of the service provider providing the social networking service and the server 606 of the insurance company are operated respectively by different business owners. The server 605 is operated by an SNS operating company, and the server 606 is operated by the insurance company. The SNS operating company provides the SNS real interaction degree with respect to the insurance company under a contract set in advance. The insurance company pays an information fee with respect to the SNS operating company in accordance with the provision of the SNS real interaction degree. The server 605 of the SNS operating company has an application interface (API) for providing the SNS real interaction degree in accordance with a request from an external computer system. The premium update unit 604 included in the server 606 of the insurance company access the API of the server 605 and passes an authentication code showing the company as having a contract and a user ID for identifying the user 10 that is a target to thereby receive the SNS real interaction degree relating to the user 10.

Components other than the interaction degree determination unit 901 and the premium update unit 604 in FIG. 6 are similar to those in Embodiment 1, and therefore description is omitted.

Before describing the interaction degree determination unit 901, the problem in Embodiment 1 will be described. In Embodiment 1, the premium is updated in accordance with the activity amount information of the user 10. However, the activity amount information is disclosed in the SNS by the SNS management unit 603, and the activity amount information is viewable with respect to a friend (the user 20) of the user 10. Accordingly, fabrication of the activity amount information by the user 10 is prevented. However, in the case where the friend of the user 10 is a virtual friend only within the system, the user 10 may not hesitate to fabricate the activity amount information. In the case where the user 20 has had interaction only within the system and not actually met the user 10, it is likely that the user 20 is unable to notice the fabrication of the activity amount information of the user 10. Even if the user 20 can notice the fabrication of the activity amount information, there is little disadvantage for the user 10 in losing trust of a friend only within the system. Thus, there is a possibility that disclosure of the activity amount information in the SNS does not act as a deterrent for inhibiting fabrication of the activity amount information.

In order to solve the problem, the premium update system in Embodiment 2 includes the interaction degree determination unit 901 to determine the SNS real interaction degree showing that the friendly relationship of the user 10 in the SNS management unit 603 is a friendly relationship sufficient to act as a deterrent for inhibiting the fabrication of the activity amount. The premium update unit 604 updates the premium based on the determined SNS real interaction degree.

It is possible for the interaction degree determination unit 901 to determine the SNS real interaction degree with various methods exemplified below. Methods of determining the SNS real interaction degree can be roughly classified into two. In a first method, a user determines the SNS real interaction degree in accordance with whether or not a real attribute instead of a virtual attribute is presented to the SNS side. In a second method, the SNS real interaction degree is determined in accordance with whether or not interaction in the SNS is performed with a real attribute presented to the SNS side.

In the world of Internet in which the actual appearance is not seen, it is possible to create a virtual personality to interact with other people, while hiding the real attribute. Typically, it is possible to interact on the Internet with a false gender. In such a state, even a system in which the activity amount is transmitted to the SNS management unit 603 and made viewable does not act as a deterrent against an intent to fabricate the activity amount. The reason is that many of the articles showing the recent situation are fabricated in the first place.

Thus, merely presenting a real attribute of a real personality instead of a virtual personality to the SNS side increases credibility of an article in the SNS. At least, with a real name being released, an article of a false gender cannot be posted. That is, a real name being released acts as a deterrent for inhibiting the fabrication of the activity amount. This perspective is the basic idea in a method of determining the SNS real interaction degree with the first method described above.

Further, if a real attribute is disclosed on the SNS and it is confirmed that interaction is performed with a real friend, the credibility of an article in the SNS increases further. A normal human being is social and therefore refrains from actions to lose trust of a real friend. Thus, interaction with a different user on the SNS further acts as a deterrent for inhibiting the fabrication of the activity amount. This perspective is the basic idea in a method of determining the SNS real interaction degree with the second method described above.

An example is shown below for a method of determining the SNS real interaction degree with the first method.

(1) In the case where the real name of the user 10 is displayed to be viewable to a viewer together with an article transmitted by the user 10 (policy holder), the interaction degree determination unit 901 increases the SNS real interaction degree. In the case where an acquired image of an official identification of the user 10 (policy holder) and the real name of the user 10 registered by the user 10 match, the interaction degree determination unit 901 determines the real name as real and increases the SNS real interaction degree.

In the case where the account name of the user registered in the SNS management unit 603 is a real name instead of an alias and an official identification authenticating the real name is presented to the SNS management unit 603, the SNS real interaction degree increases further. The official identification includes, for example, a driver's license or insurance card. The official identification does not need to be presented in person to a staff operating the SNS management unit 603. The terminal 611 may electronically image the driver's license or insurance card with a scanner and transmit the image to the SNS management unit 603. Further, the SNS management unit 603 may read a text from the transmitted image and cross-check the read text and a name input by the user. That is, it is possible to realize the presentation of the official identification with a method or device using a computer instead of by hand.

The image of the driver's license or insurance card includes the address of the user. Therefore, in the case where the address of the user is presented to the SNS management unit 603, the SNS real interaction degree obviously increases further. That is, in the case where the address of the user 10 is displayed to be viewable to a viewer together with an article transmitted by the user 10 (policy holder), the interaction degree determination unit 901 may increase the SNS real interaction degree. In the case where the acquired image of the official identification of the user 10 (policy holder) and the address of the user 10 registered by the user 10 match, the interaction degree determination unit 901 may determine the address as real.

(2) In the case where a face image of the user 10 is displayed to be viewable to a viewer together with an article transmitted by the user 10 (policy holder), the interaction degree determination unit 901 increases the SNS real interaction degree. If an icon image of the account of the user in the SNS is a headshot of the user instead of a scenery, static object, painting, or the like, the SNS real interaction degree increases further.

(3) If the face image of the user disclosed in the SNS is the same as a face image included in the official identification such as the driver's license transmitted by the user, the SNS real interaction degree increases further. That is, in the case where the acquired image of the official identification of the user 10 (policy holder) and the face image of the user 10 registered by the user 10 match, the interaction degree determination unit 901 determines the face image as real and increases the SNS real interaction degree.

(4) In the case where information relating to an organization to which the user belongs such as the alma mater or company and the first and last name of the user are registered, the SNS management unit 603 performs an Internet search with the organization name and the first and last name as a search keyword. In the case where it is confirmed that a person with the registered first and last name exists in the registered organization as a result, the SNS real interaction degree increases further. For example, in the case where an academic paper mentioning the registered organization name and first and last name is included in the search result, it is likely that the person of the registered first and last name belongs to the registered organization.

In the case where a headshot at the end of the academic paper included in the search result and the headshot of the icon of the account are cross-checked with a face authentication technique and it is determined as the same person, the SNS real interaction degree increases further.

The SNS management unit 603 may search for the registered organization name (applicant) and the registered first and last name (inventor) from disclosed patent literatures. In the case where a patent literature including the registered organization and the registered first and last name exists as a result, the SNS real interaction degree increases further. The target of the Internet search may be all web pages of websites of a so-called search service. Search for an academic paper, for example, may be performed only with respect to a website dedicated to papers. Further, search for a patent literature may be performed only with respect to a patent database. The SNS management unit 603 may determine whether or not the registered first and last name exists in a website (such as record of an alumni reunion of an alma mater, a laboratory of a university, or a sports event for related persons of an organization) operated by one's registered organization or an organization relating to one's registered organization, although the reliability is lower than an academic paper or patent literature that is an official document. In the case where the registered first and last name exists, the SNS real interaction degree increases further.

In the case where the SNS management unit 603 utilizes a website in which the number of people with a certain name within the country is counted and there are a predetermined number or more people of the registered name, the SNS real interaction degree decreases compared to a case where there are less than the predetermined number of people of the registered name. Accordingly, the risk of a case where a person with the same first name and last name is falsely recognized can be reduced. On the other hand, in the case where the registered name is an extremely uncommon name, i.e., in the case where there are less than the predetermined number of people of the registered name, the SNS real interaction degree obviously increases.

(5) In the case where the address is registered together with the first and last name, the SNS real interaction degree increases. For example, in the case where a website of a post office is utilized and it is determined that the registered address is not a fake but a surely existing address, the SNS real interaction degree increases further. Further, in the case where the registered postal code shows the registered address, the SNS real interaction degree increases further. In the case where the address is registered by a smartphone, the position in which the user is performing registration is identified from a GPS signal acquired by the smartphone. In the case where the identified position matches the registered address, the SNS real interaction degree increases further.

The first determination method is not limited to the method described above. Other methods can be used, as long as the amount of real attributes of the user presented to the SNS can be evaluated.

Next, an example is shown below for a method of determining the SNS real interaction degree with the second method.

(6) In the case where the account name confirmed as the real name with the method in (1) described above has been searched for by a different user within the SNS, and a friendly relationship has been made on the SNS for the user corresponding to the account name and the different user due to the search result, the SNS real interaction degree increases further. A friendly relationship on the SNS means that users are associated as friends. For example, in the case where the user 20 desires to become a friend of the user 10 on the SNS, the user 20 checks with the user 10 whether it is acceptable to become friends on the SNS. In the case where the user 10 has approved, the user 10 and the user 20 are associated as friends. In that case, identification information for identifying the user 20 is associated with respect to identification information for identifying the user 10 and stored. The SNS real interaction degree may be increased as the number of users with which a friendly relationship has been made with the method described above increases.

That is, with the SNS management unit 603, the user 10 (policy holder) and a viewer in a friendly relationship with the user 10 are associated and stored. In the case where the number of times the real name of the user 10 has been searched for by a viewer, or the number of times a viewer that has searched for the real name of the user 10 and the user 10 have been associated with each other as being in a friendly relationship is large, the interaction degree determination unit 901 increases the SNS real interaction degree.

(7) In the case where an image including the face image of the user 10 that has been determined to be the same as the face image included in the official identification with the method of (3) described above is transmitted from a different user other than the user 10, the SNS real interaction degree increases further. That is, the SNS management unit 603 determines whether or not the face image of the user 10 is included in the image transmitted from the different user other than the user 10. In the case where it is determined that the face image of the user 10 is included in the image transmitted from the different user, a predetermined SNS real interaction degree is given to the user 10. In the case where a face image of the user 20 in a friendly relationship with the user 10 on the SNS is included in the image transmitted from the different user, the SNS real interaction degree increases further. Further, in the case where the face image of the user 20 is determined to be the same as a face image included in an official identification with the method of (3) described above, the SNS real interaction degree increases further.

In the case where an image including a face image that can be determined to be of the same face as in the face image of the user 10 (policy holder) has been transmitted a large number of times from a viewer, the interaction degree determination unit 901 increases the SNS real interaction degree.

(8) If there is a friendly relationship with a user with a high SNS real interaction degree, the SNS real interaction degree increases further. That is, in the case where the SNS real interaction degree of a different user in a friendly relationship with the user 10 is a predetermined value or greater, the SNS management unit 603 gives a predetermined SNS real interaction degree to the user 10. With the SNS management unit 603, the user 10 (policy holder) and a viewer in a friendly relationship are associated and stored. The interaction degree determination unit 901 determines the SNS real interaction degree of the user 10 in accordance with the level of the SNS real interaction degree of the viewer associated as being in a friendly relationship with the user 10 in the SNS management unit 603.

The interaction degree determination unit 901 gives the user 10 a predetermined value of SNS real interaction degree every time the condition described in (1) to (8) described above is satisfied. For example, in the case where the user 10 discloses the real name on the SNS, the interaction degree determination unit 901 gives an SNS real interaction degree of “10” to the user 10. In the case where the user 10 discloses the address on the SNS, the interaction degree determination unit 901 gives an SNS real interaction degree of “10” to the user 10. The interaction degree determination unit 901 adds the given SNS real interaction degrees.

The second determination method is not limited to the method described above. Other methods can be used, as long as how much interaction of a user with a real friend is reflected in the SNS can be evaluated.

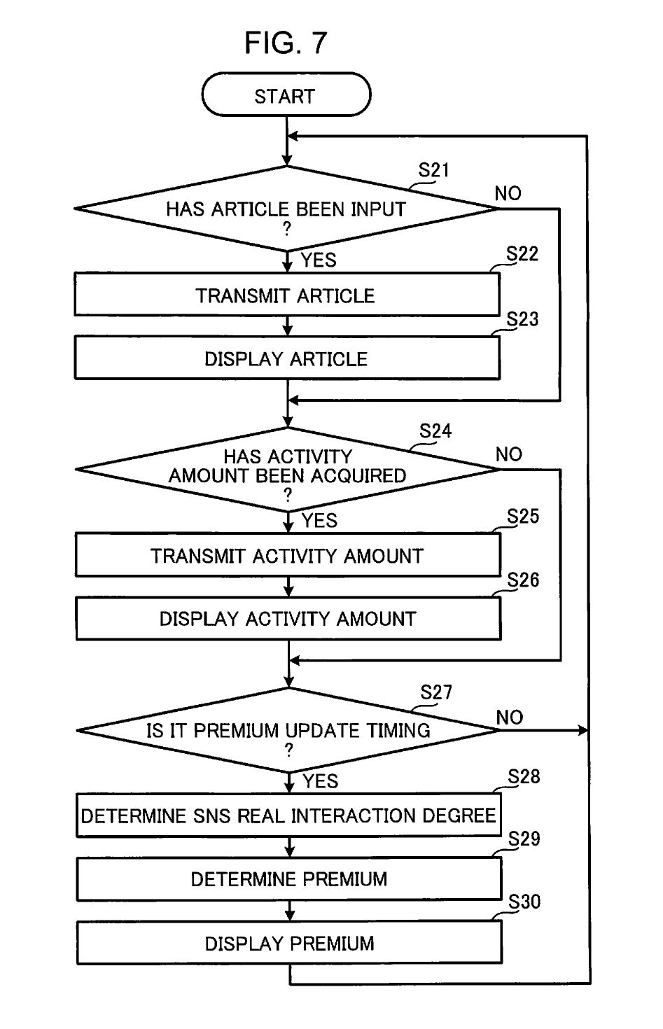

FIG. 7 is a flowchart for illustrating the operation of the premium update system in Embodiment 2 of the present invention.

The processing in step S21 to step S27 is the same as the processing in steps S1 to S7 in FIG. 3, and therefore description is omitted.

In the case where it is determined as a premium update timing (YES in step S27), the premium update unit 604 requests the SNS real interaction degree with respect to the interaction degree determination unit 901, and the SNS real interaction degree is determined and transmitted to the premium update unit 604 by the interaction degree determination unit 901 in step S28. The interaction degree determination unit 901 determines the SNS real interaction degree with the method described above.

Next, in step S29, the premium update unit 604 determines the premium using the received activity amount and the SNS real interaction degree determined by the interaction degree determination unit 901. A method of determining the premium using the activity amount and the SNS real interaction degree will be described later.

Next, in step S30, the premium update unit 604 transmits the determined premium to the terminal 611 of the user 10, and the terminal 611 displays the received premium. Then, it returns to the processing in step S21, and the processing of steps S21 and thereafter is performed.

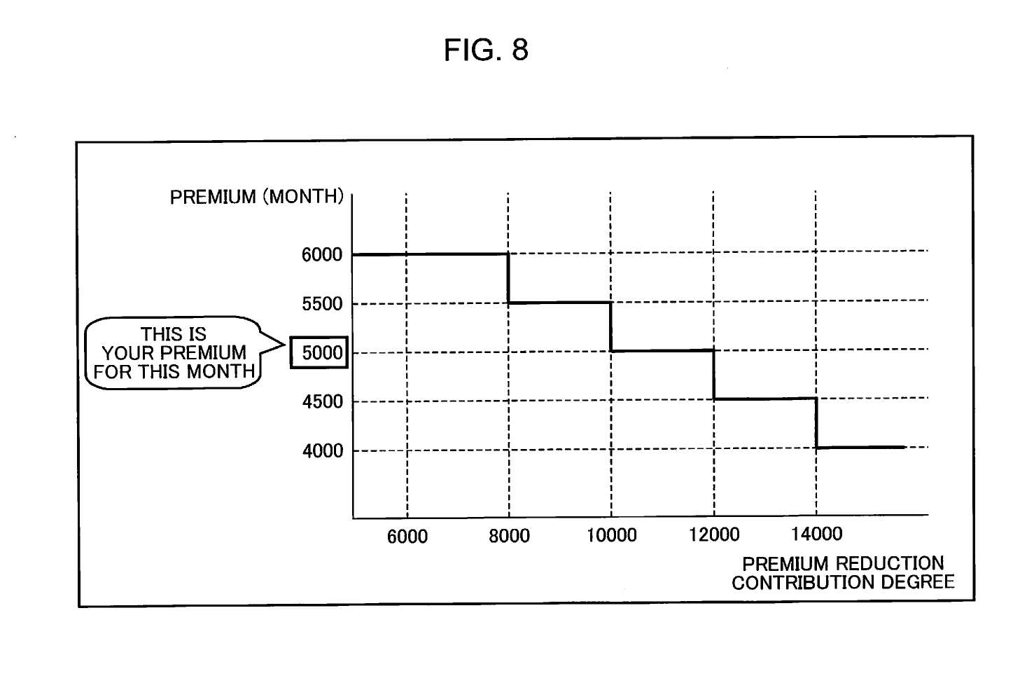

An example of determining the premium using the SNS real interaction degree determined in a manner described above is shown in FIG. 8. FIG. 8 is a diagram showing one example of a display screen notifying the user 10 of the updated premium using the SNS real interaction degree in Embodiment 2. The difference from FIG. 5 is that the numerical value of the abscissa is not the number of steps but a premium reduction contribution degree. The premium reduction contribution degree is obtained by multiplying an average number of steps per day and an interaction degree conversion value, as shown in the following expression (1).

Premium reduction contribution degree=Average number of steps per day×Interaction degree conversion value (1)

In the case where the acquired numerical value measured by a pedometer is reflected in the SNS with a reality of sufficient credibility of not being fabricated, the interaction degree conversion value is “1.” In the case where the acquired numerical value of the number of steps is completely incredible, the interaction degree conversion value is “0.” For example, in the case where the SNS real interaction degree determined with the first method and the second method is a predetermined threshold value or greater, the interaction degree conversion value is set to 1. In the case where the SNS real interaction degree is smaller than the threshold value, the interaction degree conversion value is set to a value of the SNS real interaction degree divided by the threshold value. Accordingly, the interaction degree conversion value takes a value from 0 to 1.

By multiplying the number of steps by the interaction degree conversion value calculated using the SNS real interaction degree, the premium reduction contribution degree takes a value from 0 to the number of steps. That is, the interaction degree conversion value being 1 indicates that the real interaction between users is sufficiently reflected in the SNS, and the number of steps transmitted to the SNS management unit 603 is sufficiently probable. Thus, the premium reduction contribution degree directly takes a value acquired by the activity amount acquisition unit 601. The interaction degree conversion value being 0.5 indicates that the real interaction between users is not sufficiently reflected in the SNS, and only approximately half of the number of steps transmitted to the SNS management unit 603 is credible. Thus, the premium reduction contribution degree is half the value acquired by the activity amount acquisition unit 601. The premium update unit 604 updates the premium with a graph shown in FIG. 8, using the premium reduction contribution degree calculated in this manner. In the case where the interaction degree conversion value is 0, i.e., the real interaction is completely not reflected in the SNS, as can be seen from the graph shown in FIG. 8, the premium reduction contribution degree is also 0, and the premium is not reduced even if the acquired number of steps is large.

In this Embodiment 2, as described above, the insurance company signs a medical insurance contract or life insurance contract with the user 10 with a condition that the user 10 posts an article of the activity amount to the SNS, and the premium is updated in accordance with the SNS real interaction degree. However, the present invention is not limited as such. The insurance company may determine whether or not the SNS real interaction degree of the user 10 satisfies a certain standard before the insurance contract is made and, if the SNS real interaction degree does not satisfy the certain standard, reject the insurance contract with the condition of posting the activity amount to the SNS.

It may be such that the server 605 including the SNS management unit 603 includes the interaction degree determination unit 901, and the service provider operating the server 605 sells the determined SNS real interaction degree to the insurance company. The server 606 operated by the insurance company may include the interaction degree determination unit 901. A server operated by a third service provider that is not the service provider of either the insurance company or the SNS may include the interaction degree determination unit 901.

With Embodiment 2, as described above, the premium can be updated by the interaction degree determination unit 901 in accordance with the degree of reflection of the real interaction in the SNS. Accordingly, a significant effect of enabling further reduction of the risk associated with the update of the premium can be obtained.

The SNS real interaction degree does not need to be a single numerical value and may be n-dimensional vector data. For example, the SNS real interaction degree may be configured of two numerical values of a first numerical value and a second numerical value. It may be such that the first numerical value shows the amount of a real attribute provided to the SNS side, and the second numerical value shows the degree of interaction with a different user on the SNS.

### Embodiment 3

In Embodiment 2, the interaction degree determination unit 901 is applied to Embodiment 1. However, the interaction degree determination unit 901 can also be applied to other embodiments.

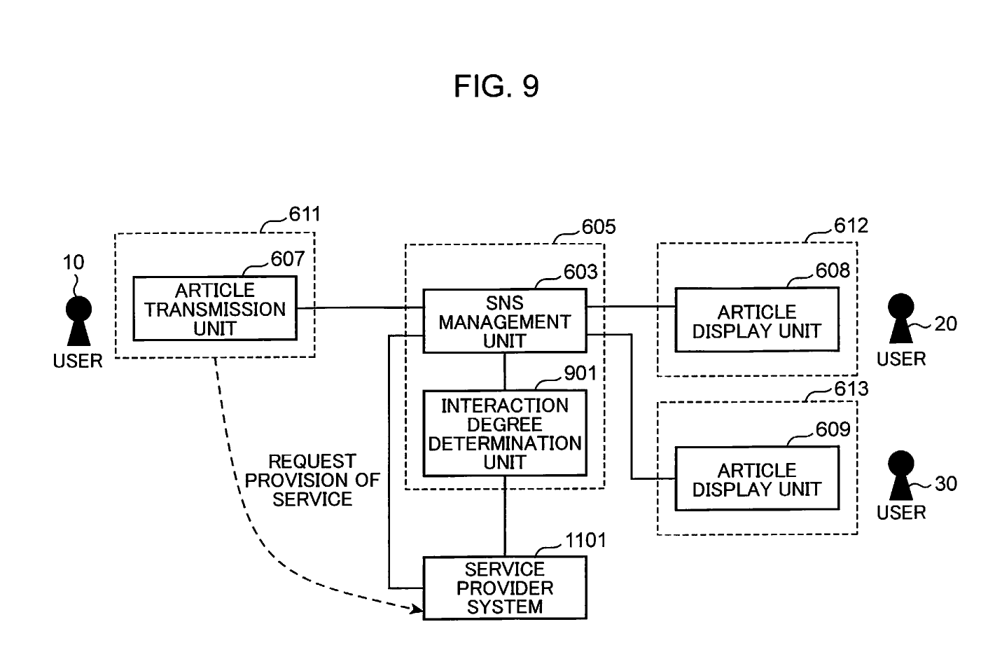

FIG. 9 is a diagram showing the configuration of a service providing system in Embodiment 3 of the present invention. Embodiment 3 is a different embodiment utilizing the interaction degree determination unit 901. The service providing system shown in FIG. 9 includes the SNS management unit 603, the article transmission unit 607, the article display units 608 and 609, the interaction degree determination unit 901, and a service provider system 1101.

In FIG. 9, the service provider system 1101 is a computer system operated by a service provider providing a certain type of service with respect to the user 10. The service provider referred to herein extensively shows a business operator that performs a business of receiving remuneration from the user 10 and providing a certain type of service, while taking a certain type of risk. Such a service provider is typically a rental business operator or finance company.

The business of a rental business operator is to receive remuneration and rent a good, and there is always a risk of the rented good not being returned. In order to reduce the risk, a rental business operator asks for presentation of a driver's license with respect to a user, for example. This is to reduce the risk by contacting the user when a rented good is not returned. On the assumption that a good may not be returned from a user, a rental business operator purchases a theft insurance as a measure.

Clarifying the identification of a user through presentation of a driver's license does lead to a reduction of the risk, compared to a case where a driver's license is not presented. However, the risk of a part of users not returning a good cannot be eliminated. Further, although the risk can be reduced by purchasing a theft insurance, the premium of the theft insurance causes an increase in remuneration for the rental. That is, because of some users, a user of a rental service is regarded as possibly stealing a good by the rental business operator, even though the person does not have an intention to steal. The corresponding risk is causing an increase in the rental fee in the current situation. This is a disadvantage for both the rental business operator and the user.

This Embodiment 3 overcomes the disadvantage by utilizing the SNS management unit 603 and the interaction degree determination unit 901.

In FIG. 9, the user 10 has an account of the SNS managed by the SNS management unit 603. Further, the user 10 interacts with the user 20 and the user 30 that are real friends also in the SNS managed by the SNS management unit 603.

The service provider system 1101 is a system using a computer that is operated by the service provider providing the service with respect to the user 10 and has an account of the SNS managed by the SNS management unit 603.

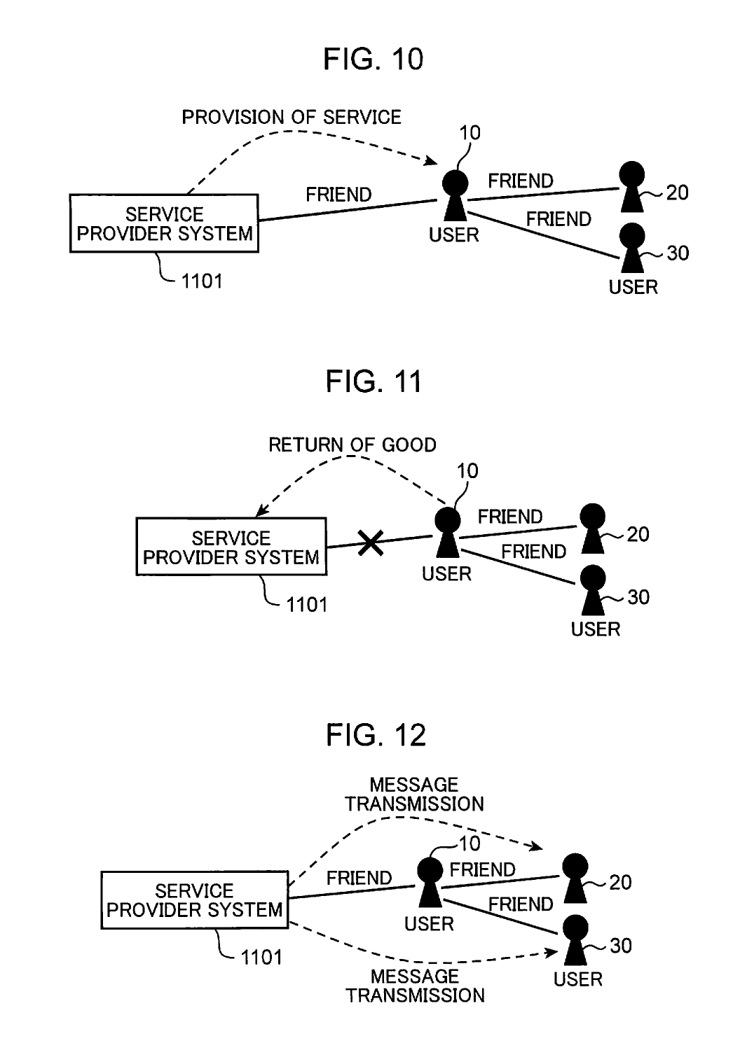

The user 10 requests provision of the service with respect to the service provider. For example, the terminal 611 requests rental of a good with respect to the service provider system 1101. The service provider system 1101 acquires the SNS real interaction degree relating to the user 10 determined by the interaction degree determination unit 901. The service provider system 1101 determines whether or not the acquired SNS real interaction degree is sufficiently high, i.e., whether or not the acquired SNS real interaction degree is a predetermined value or greater. In the case where it is determined that the SNS real interaction degree is sufficiently high, the service provider system 1101 commands the SNS management unit 603 to transmit a friend approval request for approval of association as a friend with respect to the account of the user 10. The user 10 approves the friend approval request. Then, the SNS management unit 603 associates the user 10 and the service provider as friends. Accordingly, a relationship as shown in FIG. 10 is established.

In the case where it is determined that the SNS real interaction degree is low, i.e., in the case where it is determined that the SNS real interaction degree is smaller than the predetermined value, the service provider system 1101 may notify that a good cannot be rented with respect to the terminal 611 of the user 10. In this manner, the service provider system 1101 determines whether or not a good is to be rented to a policy holder in a rental contract in accordance with the SNS real interaction degree determined by the interaction degree determination unit 901.

FIG. 10 is a schematic diagram for illustrating the relationship of the user and the service provider upon starting provision of the service. The user 10 and the service provider system 1101 are associated as friends on the SNS. The user 20 and the user 30 that are real friends of the user 10 and the user 10 are associated as friends on the SNS. The service provider that has confirmed that such relationships are established receives the remuneration from the user 10 and provides the service, i.e., performs rental of a good.

FIG. 11 is a schematic diagram for illustrating the relationship of the user and the service provider in the case where the user 10 has returned a good before passing of a return deadline. After return of the good has been confirmed, the service provider system 1101 commands the SNS management unit 603 to cancel the friendly relationship for the account of the service provider system 1101 and the account of the user 10. The SNS management unit 603 cancels the association of the service provider system 1101 and the user 10 as friends. Accordingly, the commercial transaction regarding the rental is completed.

FIG. 12 is a schematic diagram for illustrating the relationship of the user and the service provider in the case where the user 10 has not returned a good even upon passing of a return deadline. In the case where a good is not returned even upon passing of a return deadline, the service provider system 1101 commands the SNS management unit 603 to transmit a message that the user 10 has not returned the good, with respect to the user 20 and the user 30 that are associated as friends of the user 10 by the SNS management unit 603. For the transmission of the message, it is possible to use a message function in Facebook (registered trademark), for example. In the case where the SNS is Facebook (registered trademark), for example, the service provider 110 can transmit the message with respect to the user 20 and the user 30 if the service provider system 1101 has become friends with the user 10 on the SNS, since a message can be transmitted with respect to a friend of a friend.

For the user 10, the message that a good is not returned being sent to a real friend is deeply shameful. Thus, the service provider system 1101 being associated with the user 10 as a friend on the SNS acts as a strong deterrent against running away with a good. That is, for the service provider, the risk of theft can be reduced greatly by confirming that the interaction with a real friend is reflected on the SNS based on the SNS real interaction degree determined by the interaction degree determination unit 901 and setting a situation where a message can be transmitted to the friend of the policy holder. Thus, a rental business operator can reduce the rental fee, since the premium of a theft insurance can be reduced. This is an advantage for both the rental business operator and the user.

In this Embodiment 3, the service provider system 1101 becomes a friend of the user 10 on the SNS, but this configuration is not a requisite. Merely being able to confirm that the user 10 is a person engaged in healthy social interactions and not a person that would run away with a good with the SNS real interaction degree determined by the interaction degree determination unit 901 can reduce the risk relating to theft of a good.

In this Embodiment 3, the service provider provides the service of renting a good. However, the present invention is also applicable to other services. For example, a service provider may provide a service of financing. In this case, a good is money, and the return of a good is the return of money with interest.

Already, on the Internet, a financing system exists in which a designated bank account is credited merely by electronically transmitting all documents necessary for procedures of financing. A customer undergoes a financing examination by transmitting an image of an identification such as a driver's license. In such a financing system, a customer can receive financing conveniently merely by operating a personal computer at home, but needs to go through the trouble of transmitting an image of an identification. While the financing system receives an identification electronically, checking of the received identification is done by a human, and there is a problem that a financing examination requires human labor.

The service providing system in this Embodiment 3 can be applied to the financing system described above. First, a financing company signs a contract in advance with the service provider providing the SNS in order to receive provision of the SNS real interaction degree. The SNS management unit 603 sets up a page that accepts an application for financing, within a website of the SNS. A customer that wants to receive financing logs into the SNS. A financing page set up within the website of the SNS is shown, and an application for financing is performed.

At this time, the SNS management unit 603 calls an API for accepting financing in the service provider system 1101 of the financing company. Calling is done by the SNS management unit 603 with the ID of the customer on the SNS as an argument. The service provider system 1101 acquires the SNS real interaction degree by calling an API for acquiring the SNS real interaction degree that is prepared in the server 605 operated by the service provider of the SNS with the ID of the customer on the SNS as an argument.

The service provider system 1101 determines whether or not the acquired SNS real interaction degree is sufficiently high, i.e., whether or not the acquired SNS real interaction degree is a predetermined value or greater. In the case where it is determined that the SNS real interaction degree is sufficiently high, the service provider system 1101 regards the financing examination to be passed and credits a bank account of the designated customer.

In the case where it is determined that the SNS real interaction degree is low, i.e., in the case where it is determined that the SNS real interaction degree is smaller than the predetermined value, the service provider system 1101 may notify that financing cannot be provided with respect to the terminal 611 of the user 10. In this manner, the service provider system 1101 determines whether or not to provide financing for a policy holder in a financing contract in accordance with the SNS real interaction degree determined by the interaction degree determination unit 901.

For the customer, an effect can be obtained in which one's credibility can be proved without transmitting an identification or the like, by utilizing the SNS real interaction degree in this manner. For the financing company, an effect can be obtained in which human labor for financing examination can be considerably reduced, since the financing examination is performed only with numerical value data of the SNS real interaction degree.

With Embodiment 3 described above, the risk of a commercial transaction for a service provider can be considerably reduced, and remuneration paid by a user can be reduced, by the interaction degree determination unit 901 confirming that a real interaction is reflected in the SNS and further associating the service provider with a friend of the user on the SNS.

### Embodiment 4

Conventionally, a rental business operator has asked for presentation of a driver's license with respect to a user before providing a service. However, with a service providing system in this Embodiment 4, a service can be provided more conveniently.

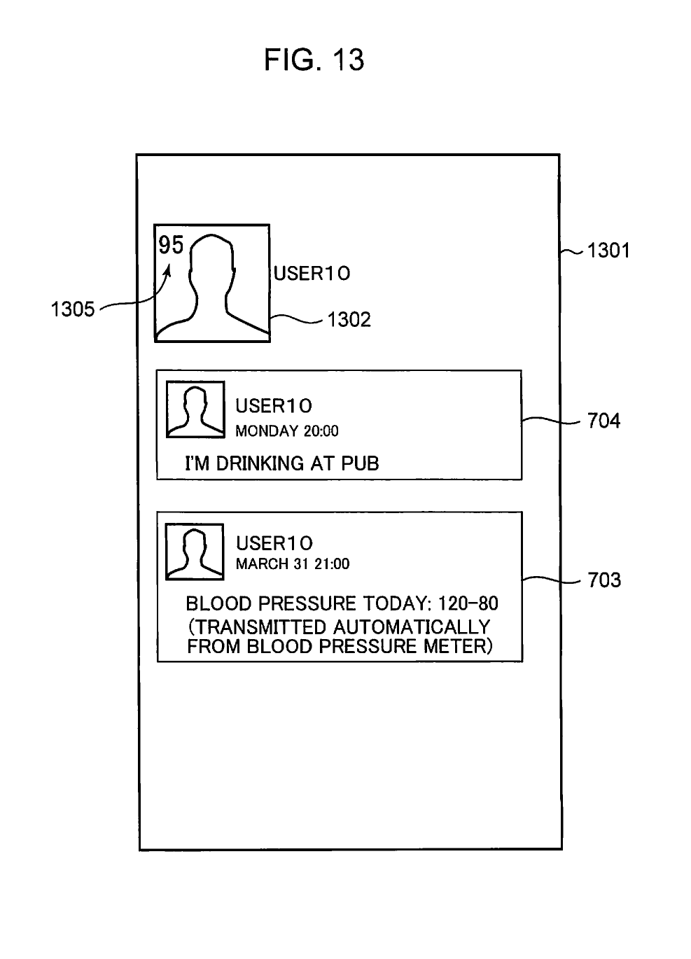

FIG. 13 is a diagram showing one example of a display screen displayed by the article display unit 608 in Embodiment 4. In a display screen 1301, the article 704 transmitted by the user 10 is displayed, and the activity amount of the user 10 acquired by the activity amount acquisition unit 601 is displayed as the article 703. An icon 1302 represents a face image of the user 10. The icon 1302 includes an SNS real interaction degree 1305 of the user 10 determined by the interaction degree determination unit 901. The SNS real interaction degree 1305 is represented by a numerical value and displayed in the upper left portion within the icon 1302 of the user 10.

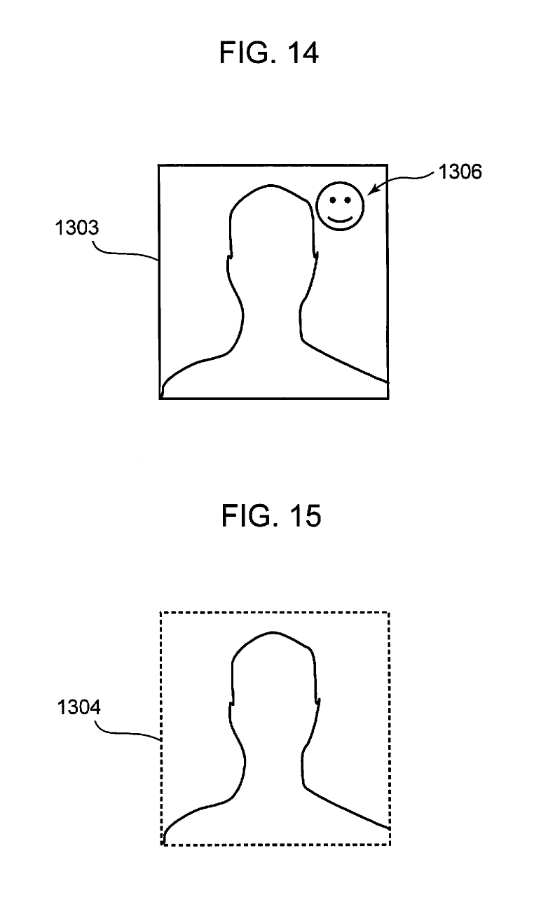

FIG. 14 is a diagram showing another example of an icon within a display screen displayed by the article display unit 608 in Embodiment 4. An icon 1303 in FIG. 14 includes a mark 1306 showing that the SNS real interaction degree exceeds a predetermined threshold value, in the case where the SNS real interaction degree of the user 10 is a predetermined threshold value or greater. In the case, it is represented by a shape given to the icon. In the case where the SNS real interaction degree of the user 10 is smaller than the predetermined threshold value, the mark 1306 is not displayed.

FIG. 15 is a diagram showing another example of an icon within a display screen displayed by the article display unit 608 unit in Embodiment 4. In FIG. 15, a decoration showing that the SNS real interaction degree exceeds a predetermined threshold value is given in the outer circumference portion of an icon 1304, in the case where the SNS real interaction degree of the user 10 is the predetermined threshold value or greater.

Upon requesting provision of a service to a service provider, the user 10 presents an account screen of the SNS of him/herself that is displayed in a terminal such as a smartphone. The service provider adjusts the providing condition of the service in accordance with the SNS real interaction degree displayed in the presented account screen.

As shown in Embodiment 2, the value of the SNS real interaction degree increases in the case where the user 10 presents a driver's license or the like with respect to the SNS side and the account name is confirmed to be the real name. That is, confirming that the SNS real interaction degree is at the predetermined threshold value or greater in the account screen of the user in the SNS means that the service provider has checked the driver's license, and it becomes unnecessary to ask for presentation of the driver's license. For the user, there is a significant effect that the service can be received without presenting the driver's license.

The service provider checks the SNS real interaction degree in the account screen of the user 10 in the SNS. When it is determined that the SNS real interaction degree of the user 10 is the predetermined threshold value or greater, the service provider inputs a command with respect to the service provider system 1101 such that a friendly relationship is made for the service provider and the user 10. The service provider system 1101 accepts the input from the service provider and commands the SNS management unit 603 to transmit a friend approval request for approving association as a friend with respect to the account of the user 10. The user 10 approves the friend approval request. The SNS management unit 603 associates the user 10 and the service provider as friends. Accordingly, the following two effects occur.

As a first effect, it can be confirmed that the account screen of the user 10 in the SNS presented by the user 10 is not a fabricated image irrelevant to the SNS, by the service provider confirming through the service provider system 1101 that a friendly relationship has been surely made on the SNS for the service provider system 1101 and the user 10.

As a second effect, a query with respect to the user 10 can be performed by the service provider with respect to the account of the user 10 on the SNS, since the friendly relationship has been made for the user 10 and the service provider system 1101. Further, the service provider can perform a query with respect to a different user associated as a friend of the user 10, when the user 10 cannot be contacted. This results in an effect similar to or an effect greater than asking for an entry of the address or contact with respect to the user 10 before providing the service. The service provider asks a user for the address or contact before providing the service in the first place as a measure for when return of a rented good is delayed, particularly in order to reliably contact the user. By the service provider and the user 10 being associated as friends on the SNS, it becomes possible for the service provider to contact the user 10 using the SNS, and it further becomes possible to contact a different user associated as a friend of the user 10. Therefore, a measure that is more than just merely knowing the address or contact can be expected. Therefore, it becomes unnecessary for the service provider for the service provider to ask for entry of the address or contact with respect to the user. That is, the user 10 can receive provision of the service, merely by showing the account screen of the SNS to the service provider and giving approval with respect to the friend approval request from the service provider.

In this embodiment, as described above, the SNS real interaction degree is displayed on the icon of the account screen of the SNS. Therefore, upon applying for provision of the service, the user only needs to present the account screen of the SNS to the service provider and approve the friend approval request from the service provider. Accordingly, presentation of a driver's license that has been conventionally performed becomes unnecessary, and a significant effect that entry of the address or contact becomes unnecessary can be obtained.

The technique described in the embodiment described above can be realized in the following types of cloud service, for example. However, the types of cloud service in which the technique described in the embodiment described above is realized are not limited as such.

(Service Type 1: Company-Owned Data Center-Type Cloud Service)

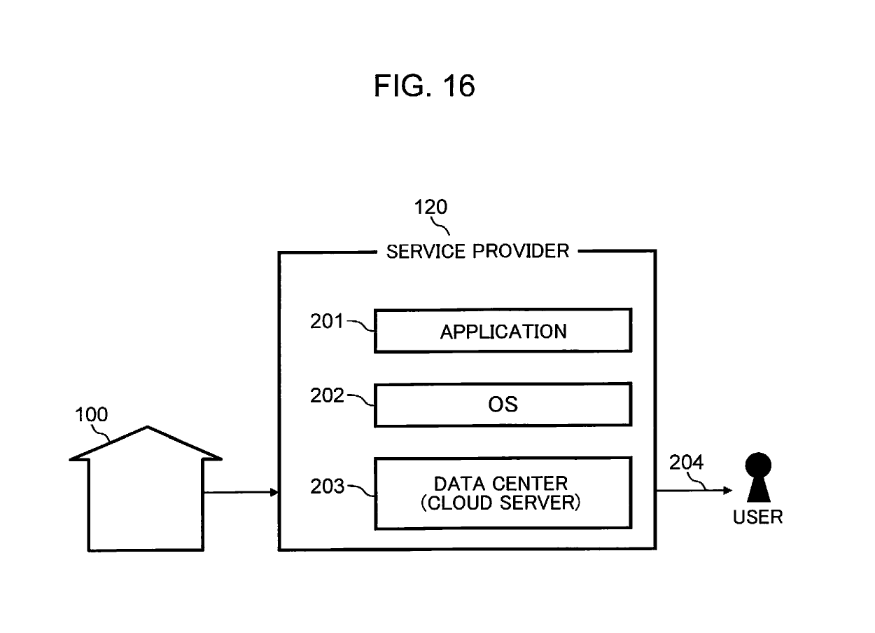

FIG. 16 is a diagram showing an overview of a service provided by an information providing system in service type 1 (company-owned data center-type cloud service). In this type, the service provider 120 acquires information from the group 100 and provides the service with respect to a user. In this type, the service provider 120 has a function of a data center operating company. That is, the service provider 120 holds a cloud server 203 that manages big data. Thus, a data center operating company is absent.

In this type, the service provider 120 operates and manages the data center (cloud server) 203. The service provider 120 manages an operating system (OS) 202 and an application 201. The service provider 120 provides the service (in an arrow 204) using the OS 202 and the application 201 managed by the service provider 120.

(Service Type 2: IaaS Utilizing-Type Cloud Service)

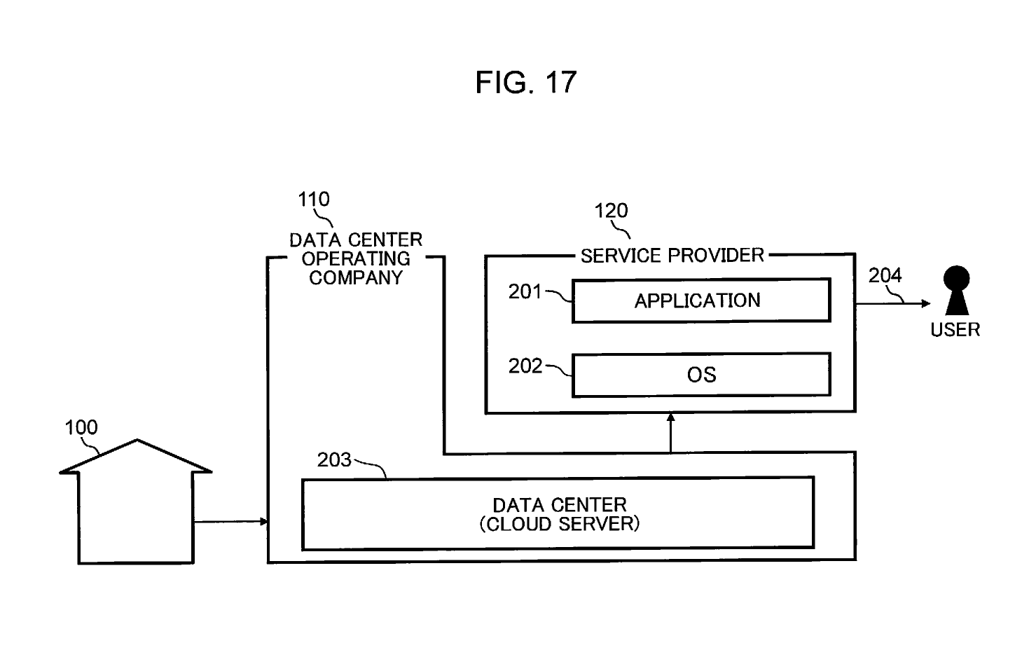

FIG. 17 is a diagram showing an overview of a service provided by an information providing system in service type 2 (IaaS utilizing-type cloud service). IaaS stands for Infrastructure as a Service and is a cloud service providing model in which an infrastructure itself for building and running a computer system is provided as a service via the Internet.

In this type, the data center operating company 110 operates and manages the data center (cloud server) 203. The service provider 120 manages the OS 202 and the application 201. The service provider 120 provides the service (in the arrow 204) using the OS 202 and the application 201 managed by the service provider 120.

(Service Type 3: PaaS Utilizing-Type Cloud Service)

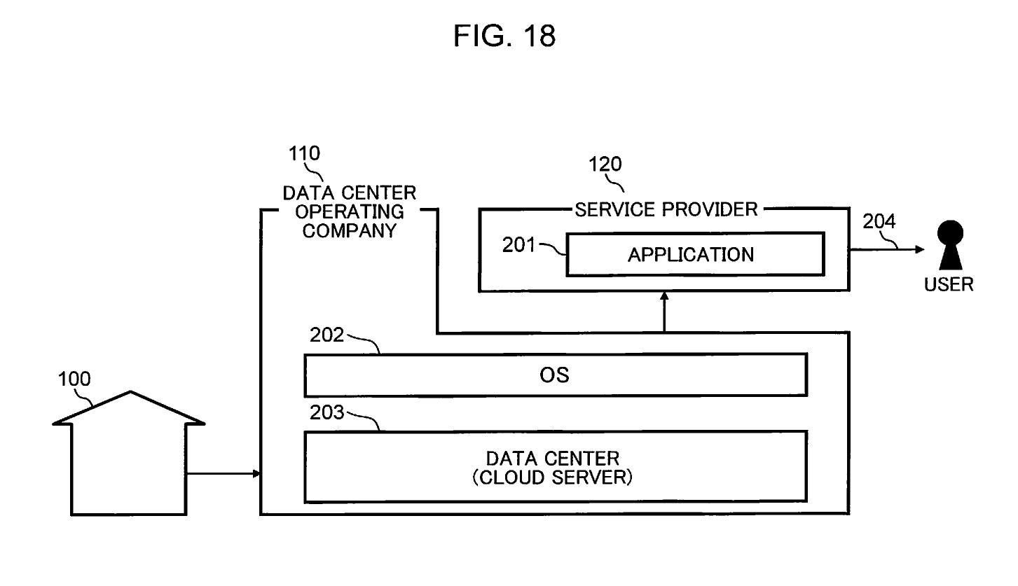

FIG. 18 is a diagram showing an overview of a service provided by an information providing system in service type 3 (PaaS utilizing-type cloud service). PaaS stands for Platform as a Service and is a cloud service providing model in which a platform as a basis for building and running a software is provided as a service via the Internet.

In this type, the data center operating company 110 manages the OS 202 and operates and manages the data center (cloud server) 203. The service provider 120 manages the application 201. The service provider 120 provides the service (in the arrow 204) using the OS 202 managed by the data center operating company 110 and the application 201 managed by the service provider 120.

(Service Type 4: SaaS Utilizing-Type Cloud Service)

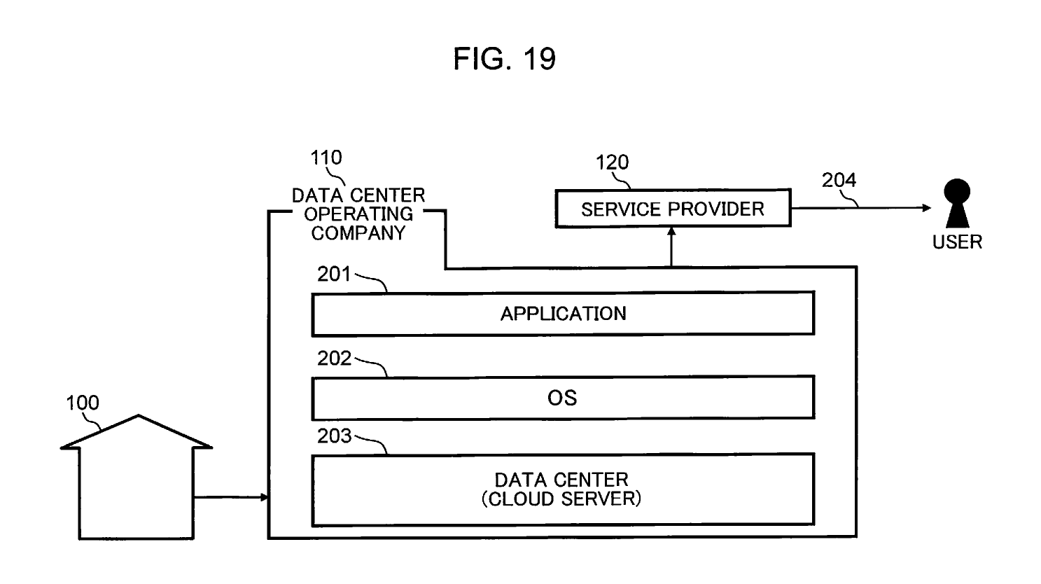

FIG. 19 is a diagram showing an overview of a service provided by an information providing system in service type 4 (SaaS utilizing-type cloud service). SaaS stands for Software as a Service. The SaaS utilizing-type cloud service is, for example, a cloud service providing model having a function with which an application provided by a platform provider holding a data center (cloud server) can be used via a network such as the Internet by a user such as a company or individual not holding the data center (cloud server).

In this type, the data center operating company 110 manages the application 201, manages the OS 202, and operates and manages the data center (cloud server) 203. The service provider 120 provides the service (in the arrow 204) using the OS 202 and the application 201 managed by the data center operating company 110.

In any one of the types of cloud service above, the service provider 120 provides the service. The service provider or the data center operating company may develop one's own OS, application, database of big data, or the like or may outsource to a third party, for example.

### INDUSTRIAL APPLICABILITY

A service providing method according to the present invention can reduce the risk at the time of determining the content of contract and is useful for a service providing method of providing a predetermined service with respect to a policy holder who has signed a predetermined contract with a service provider providing a predetermined service.

1-17. (canceled)

18. A service providing method comprising:
a transmitting step of transmitting via a network activity amount information showing an activity amount of a policy holder by the policy holder who has signed a medical insurance contract or a life insurance contract;
a displaying step of displaying the activity amount information transmitted in the transmitting step to a viewer other than the policy holder;
an interaction degree determining step of determining an interaction degree showing a degree of interaction relationship between the policy holder and the viewer is determined; and
a contract determining step of determining a premium in the medical insurance contract or the life insurance contract in accordance with the activity amount information displayed to a viewer other than the policy holder in the displaying step and a degree of interaction between the policy holder and the viewer determined in the interaction degree determining step.

19. The service providing method according to claim 18, wherein the interaction degree determining step is implemented such that the interaction degree is increased in a case where a real name of the policy holder is displayed to be viewable to the viewer together with the activity amount information transmitted by the policy holder.

20. The service providing method according to claim 18, wherein the interaction degree determining step is implemented such that the interaction degree is increased in a case where an address of the policy holder is displayed to be viewable to the viewer together with the activity amount information transmitted by the policy holder.

21. The service providing method according to claim 18, wherein the interaction degree determining step is implemented such that the interaction degree is increased in a case where a face image of the policy holder is displayed to be viewable to the viewer together with the activity amount information transmitted by the policy holder.

22. The service providing method according to claim 19, further comprising:
an image acquiring step of acquiring an image of an official identification of the policy holder, wherein
the interaction degree determining step is implemented such that, in a case where an image of an official identification of the policy holder acquired in the image acquiring step match a real name, an address, or a face image of the policy holder registered by the policy holder, the real name, the address, or the face image is determined as real, and the interaction degree is increased.

23. The service providing method according to claim 18, further comprising:
a storing step of associating the policy holder with a viewer who is a friend of the policy holder and storing the friendly relationship between the policy holder with the viewer, wherein
the interaction degree determining step is implemented such that the interaction degree is increased in a case where the number of times a real name of the policy holder has been searched for by the viewer, or the number of times the viewer who has searched for a real name of the policy holder and the policy holder have been associated with each other as being in a friendly relationship is large.

24. The service providing method according to claim 18, further comprising:
a storing step of associating the policy holder with a viewer who is a friend of the policy holder and storing the friendly relationship between the policy holder with the viewer, wherein
the interaction degree determining step is implemented such that the interaction degree of the policy holder is determined in accordance with a level of interaction degree of the viewer associated as being in a friendly relationship with the policy holder in the storing step.

25. The service providing method according to claim 18, wherein the interaction degree determining step is implemented such that the interaction degree is increased in a case where an image, which includes a face image that is determined to be of a same face as a face image of the policy holder, has been transmitted a large number of times from the viewer.

26. The service providing method according to claim 18, wherein the activity amount information includes a movement amount of the policy holder.

27. The service providing method according to claim 26, wherein the movement amount includes the number of steps taken by the policy holder.

28. The service providing method according to claim 18, wherein the activity amount information includes body information on the policy holder.

29. The service providing method according to claim 28, wherein the body information includes any of a pulse, a blood pressure, a blood sugar level, and an uric acid level of the policy holder.

30. A service providing method comprising:
an everyday information transmitting step of transmitting, by a policy holder who has signed with a business operator providing a predetermined service a contract relating to the service, everyday information via a network;
a contract information transmitting step of transmitting by the business operator contract information relating to the contract via a network;
a displaying step of displaying the everyday information and the contract information transmitted in the everyday information transmitting step and in the contract information transmitting step to a viewer other than the policy holder;
an interaction degree determining step of determining an interaction degree showing a degree of interaction relationship between the policy holder and the viewer; and
a contract determining step of determining content of the contract in accordance with a degree of interaction between the policy holder and the viewer determined in the interaction degree determining step.
